(19) United States
(12) Patent Application Publication
(10) Pub. No.: US 2011/0208776 A1
(43) Pub. Date: Aug. 25, 2011

(54) METHOD AND APPARATUS OF SEMANTIC TECHNOLOGICAL APPROACH BASED ON SEMANTIC RELATION IN CONTEXT AND STORAGE MEDIA HAVING PROGRAM SOURCE THEREOF

(76) Inventors: Min Ho Lee, Daejeon (KR); Yun Soo Choi, Daejeon (KR); Sung Pil Choi, Daejeon (KR); Nam Gyu Kang, Daejeon (KR); Kwang Young Kim, Cheonan-si (KR); Han Gee Kim, Daejeon (KR); Chang Hoo Jeong, Daejeon (KR); Min Hee Cho, Daejeon (KR); Hwa Mook Yoon, Daejeon (KR); Sun Hwa Hahn, Daejeon (KR)

(21) Appl. No.: 13/126,998

(22) PCT Filed: Dec. 16, 2008
(86) PCT No.: PCT/KR08/07427

§ 371 Date: Apr. 29, 2011

(30) Foreign Application Priority Data
Nov. 14, 2008 (KR) 10-2008-0113565

(51) Int. Cl. G06F 17/30

(52) U.S. Cl. 707/769; 707/758; 707/E17.069

(57) ABSTRACT

The present invention relates to a method and apparatus for extracting the semantic relations of context and a recording medium storing the program source thereof. The present invention is intended to detect technical terms by parsing full text of documents and recommend research topics using the relations therebetween using a method of searching for a first concept connected to a specific vocabulary word through a casual relationship and a second concept connected to the first concept through a causal relationship, determining the relation therebetween and performing recommendation as research topics. The present invention has the industrial utilization advantage of improving the overall search efficiency and utility of massive databases.

### TECHNICAL FIELD

The present invention relates to a method and apparatus for extracting the semantic relations of context and a recording medium storing a program source that are intended to automatically search for patterns in a large amount of data, relate a large number of documents to each other and then mine vocabulary words and that are capable of finding new knowledge for an approach to the problem of searching for undiscovered public knowledge using a method of extracting the semantic relation of context by parsing documents.

### BACKGROUND ART

Many efforts to automatically find patterns in a large amount of data and extract knowledge have established an academic field called knowledge discovery, and a lot of research is being conducted in this field. Of these efforts, Swanson defined the knowledge acquired by relating many documents to each other as Undiscovered Public Knowledge (UPK) in his paper, and conducted research into it. The knowledge acquired as described above may be effectively used to help researchers obtain ideas about new search topics. Following Swanson, various types of research for automatically extracting research topics has been conducted. Such research used statistical techniques or descriptions written by domain experts.

Furthermore, the above research has been conducted only in the biomedical field.

Swanson formulated a process of finding UPK in biomedical documents. FIG. 1 is a diagram showing Swanson's ABC model. This formulated process called Swanson's ABC model is explained as a process of inferring the hypothesis “concept A and concept C are related” from the fact that “concept A is related to concept B and concept B is related to concept C.”. This is applied to documents as follows: if the fact “term A is related to term B” is described in a document and the fact “term B is related to term C” is described in another document, the hypothesis “term A and term C are related to each other” is set up and becomes a valuable research target.

After the publication by Swanson, many related researches have been conducted in the biomedical field. Swanson used keywords in the titles of documents as concepts, whereas Hristovski attempted to extract more accurate and significant information using summaries, called MeSH descriptors, in which biomedical experts summarized the content of documents. Hristovski tried to deal with the relations between the words of summaries using an association rule algorithm. The relation rule is a statistical technique that clusters objects concurring frequently and determines that there is a relation therebetween. However, this scheme has disadvantages in that this scheme presents the presence or absence of a relation and it is difficult to clearly know the relation and in that there are a large number of combinations corresponding to A-B or B-C because this scheme is based on probability. In order to solve the problem of an excessive number of combinations, methods using filtering, sequential probability, etc. were proposed, but they are not effective.

Pratt narrowed search space by reducing the number of terms representing concepts A and B using the concepts of the Unified Medical Language System (UMLS) instead of MeSH words. The UMLS is a list of controlled terms that are used in the biomedical field. Furthermore, on the basis of the frequencies of words, excessively general terms, words excessively related to a start concept and meaningless words are eliminated. The above-described researches are approaches that chiefly use probability or the concurrence frequencies of words, and have low accuracy.

A semantic approach method was attempted by Hu. Respective concepts were defined as wider regions called semantic types using ontology defined in the UMLS, and the semantic types were limited using relation filters related thereto. However, this scheme is enabled only when experts manually write descriptions called MeSH using the controlled language UMLS, and aims only at the biomedical domain.

As a result, a method that can be applied to general fields, rather than to a specific field, is required.

### DISCLOSURE

### Technical Problem

Accordingly, the present invention has been made keeping in mind the above problems occurring in the prior art, and an object of the present invention is to propose a method for an approach to the problem of searching for Undiscovered Public Knowledge (UPK) using a method of extracting the semantic relation of context by parsing documents.

Another object of the present invention is to provide a research topic recommendation service that provides an undiscovered knowledge search application service of searching all existing documents for a relation between ‘A’ and ‘C’ on the basis of Swanson's ABC model and, if there is no relation, recommending a corresponding case to a user as a new research topic candidate.

### Technical Solution

Accordingly, in order to accomplish the above objects, the present invention provides a method of extracting a semantic relation of context, including the steps of (a) querying a specific vocabulary word; (b) searching databases for a first concept connected to the queried vocabulary word in a causal relationship; (c) searching the databases for a second concept connected to the first concept in a causal relationship; (d) determining whether there is a relation between the retrieved vocabulary word and the second concept; and (e) if there is no relation between the vocabulary word and the second concept, recommending this case as a research topic.

The step (b) includes the step of, if the first concept includes a plurality of first concepts, selecting one front among the plurality of first concepts, and the step (d) includes the step of, if it is determined that there is a relation between the vocabulary word and the second concept, excluding this case from a research topic recommendation service.

Preferably, the step (e) includes the steps of dividing documents of the databases on a basis of a specific point of time; searching documents issued before the specific point of time, and recommending a research topic; searching documents issued after the specific point of time for a relation; and, if it is determined that there is a relation at the previous step, recommending this case as a research topic.

More preferably, the step (d) includes the step of extracting vocabulary words; and the relation extraction step for mapping the vocabulary words to desired relations, and the relation extraction step includes mapping the vocabulary words to Synsets and extracting Root Synsets as relations.

Additionally, the present invention provides a recording medium recording a program source of the method of extracting the semantic relations of context.

In order to accomplish the above objects, the present invention provides an apparatus for extracting semantic relations of context, including a TRS for managing overall data for which technical terms have been detected and providing search service that can be used by other modules; a TAS for searching the data of the TRS for technical terms using dictionaries and extracting new terms; a TLA for performing chucking and tagging on source documents to facilitate detection of technical terms and relation extraction; a TAMA for extracting semantic relations of context by parsing documents among the technical terms, and performing conceptualization using WordNet; and a SATT for providing various services using the extracted semantic relations.

The apparatus further includes an IIFP for providing support so as to enable systematic access to precisely processed massive databases, and the IIFP provides various types of services using an academic database access API processed by the TAMA and the SATT.

The TAMA includes a CREM configured such that relations between technical names are very concrete and configured to perform mapping to hypernym verb synsets of the WordNet; and an AREM configured such that relations between technical names are abstract and relations are mapped at a verb semantic classification level and configured to perform mapping to a verb concept classification system of the WordNet. The TAMA extracts vocabulary words and extracts relation for mapping the extracted vocabulary words to desired relations.

The TAMA is configured to extract relations from document sets input from the TRS using part-of-speech information patterns of technical terms and vocabulary, automatically recheck existing relation information, automatically and manually verify the relations, analyze the relations using thesauruses, ontology and a word intelligent network, provide analysis results to the AREM, and provide relation information based on specific technology to a knowledge database. The relations are configured to map the vocabulary words to the Synsets and extract Root Synsets as relations.

### Advantageous Effects

The present invention constructed as described above has the industrial utilization advantages of improving the overall search efficiency and utility of massive databases because technical terms and context information based on the semantics of scientific and technological information in text are continuously and repeatedly extracted and managed.

Furthermore, the present invention has a convenient utilization advantage of facilitating examinations and development of technology because the relations between technical terms found from the text of scientific and technological information are analyzed and accumulated and then the relation, time series analysis and classification of technological information are rapidly searched for and tracked in real time.

### DESCRIPTION OF DRAWINGS

FIG. 1 is a conceptual diagram illustrating Swanson's typical ABC model;

FIG. 2 is a block diagram illustrating the overall construction of an STM system according to an example of the present invention;

FIG. 3 is a flowchart illustrating a verb phrase conceptualization step according to an example of the present invention;

FIG. 4 is a flowchart showing the relation extraction method of the STM system according to an example of the invention;

FIG. 5 is a diagram schematically showing a scheme for concept mapping based on transference to hypernyms; and

FIG. 6 is a reference diagram showing the relations of the present invention.

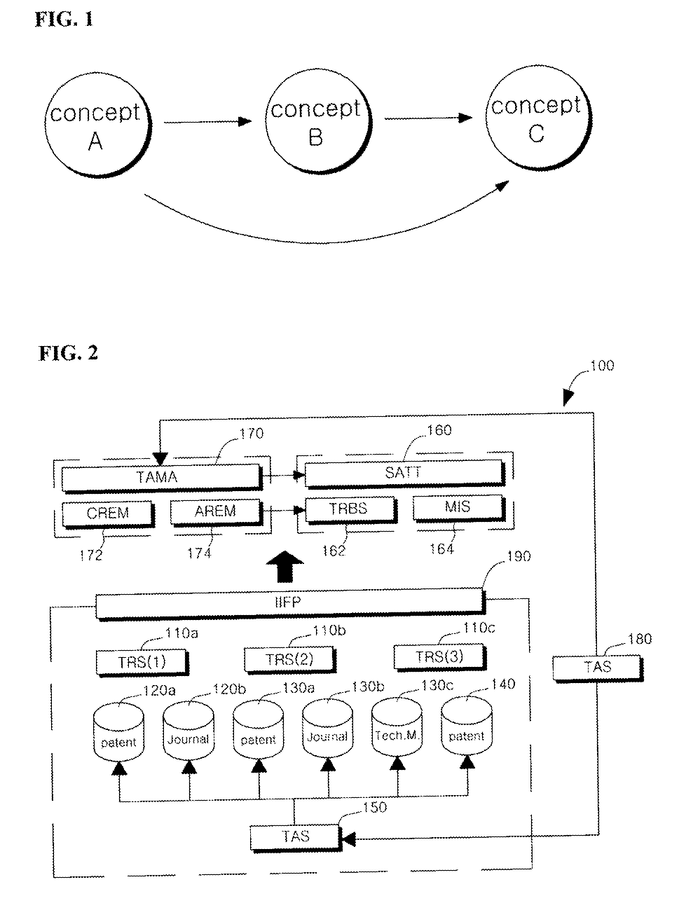

### DESCRIPTION OF REFERENCE NUMERALS OF PRINCIPAL ELEMENTS IN THE DRAWINGS

| | |
|---|---|
| 100: STM system | 110a, b, c: TRS |
| 120a, 120b, 130a, 130b, 130c, 140: document | |
| 150: TAS | 160: SATT |
| 162: TABS | 164: MIS |
| 170: TAMA | 172: CREM |
| 174: AREM | 180: TLA |
| 190: IIFP | |

### MODE FOR INVENTION

The terms and words used in the present specification and the accompanying claims should not be limitedly interpreted as having common meanings or meanings appearing in dictionaries, but should be interpreted as having meanings suitable for the technical spirit of the present invention on the basis of the principle that an inventor can appropriately define the concepts of terms in order to describe his or her invention in the best way.

The present invention relates to a method of analyzing the syntax of the document full text, recognizing technical terms and utilizing the relations therebetween, which is referred to as Scientific Tech Mining (STM) in the present invention.

Furthermore, in the present invention, the lexical clues are used to refer to nucleus words that play crucial roles in the expression of relations.

First, based on various types of existing researched ontology, relations that generate inter-concept influences or form causes are considered important relations that can be used in the UPK process. Although other relations may be applied to the UPK process, relations that can be clearly inferred based on Swanson's ABC model and can facilitate comparison due to a lot of research because the current stage is an early research stage are selected.

Thereafter, technological terms and relations therebetween appearing in foreign academic databases composed of more than thirty million documents in the scientific and technological fields, which are managed by Korean Institute of Scientific and Technology Information, have been extracted. The technological terms have been extracted based on various technological thesauruses, and various special rules or algorithms have been used to solve vocabulary deformation and process compound words in this process. Furthermore, since new technological terms that do not exist in dictionaries may appear, a method and system for enabling newly coined words to be extracted through the measurement of term specificity is being developed.

An apparatus for extracting the semantic relation of context according to an embodiment of the present invention will be described below with reference to the drawing.

FIG. 2 is a block diagram illustrating the overall construction of the apparatus for extracting the semantic relation of context (STM system) according to the embodiment of the present invention. As shown in this drawing, the STM system 100 includes TRSs 110a, 110b and 110c, documents 120a, 120b, 130a, 130b, 130c and 140, a TAS 150, a SATT 160, a TAMA 170, a TLA 180 and an IIFP 190.

First, the STM system 100 is a new concept-based system for the analysis of scientific and technological knowledge, which is capable of, in depth, analyzing the articles of the fields of science and technology, patents, and other academic data through a combination of text mining technology and information analysis technology. A conventional tech mining concept was proposed by Alan L. Poter of Search Technology Inc., which was famous for an analysis tool called ‘Vantage Point,’ in 2004. The STM system 100 has been developed as a more specific and user-friendly specialized knowledge analysis tool for the fields of science and technology using further in-depth technology (language processing technology, machine learning technology, etc.) on the basis of this concept.

The TAS (Tech Acquisition System) 150 of the STM system 100 is technical term recognition means, and is configured to search an original database for technical terms using a dictionary and to extract new terms. Original databases are processed, and technical thesauruses including 243,575 technical terms in 16 fields are searched or matching thereto is attempted. That is, the TAS 150 performs part-of-speech tagging and phrase and clause tagging on an original database using the TLA (Tech Language Analyzer) 180. In this process, various special rules or an algorithm for eliminating lexical deformation and processing compound words are used. Accordingly, the TAS 150 may be applied to a technical term automatic extraction system capable of automatically recognizing unregistered terms that do not exist in a dictionary.

The overall data for which technical term recognition has been performed by the TAS 150 is loaded in the TRS (Tech Retrieval System) 110, that is, a technology search management system, and is then managed and serviced systematically. The TRS 110 is a system that is configured to enable detailed searching for technical terms, and is extended from the functionality of a typical search engine. The TRS 110 and the TAS 150 are backbone systems that constitute the STM system 100, and perform IIFP (Integrated Information & Function Provider for an STM system) 190 that provides support to enable systematic access to a precisely processed massive database.

That is, the TRS 110 searches massive databases 120a, 120b, 130a to 130c and 140 based on a query created in the TAS 150. Search results are a set of documents each including a specific query.

Query-based searching performs searching and extraction on the basis of language information based on parts of speech and sentence constituents. For example, searching based on <noun phrase>+“AND OTHER”+“TECHNOLOGIES” is performed to search documents including “AND OTHER TECHNOLOGIES” only for documents in which a “noun phrase” is placed before “AND OTHER TECHNOLOGIES.” For another example, searching based on “TECHNOLOGIES”+“ESPECIALLY”+<noun phrase>+<noun phrase>+ . . . is performed to search documents including “TECHNOLOGIES ESPECIALLY” only for documents in which “noun phrases” repeatedly appear after “TECHNOLOGIES ESPECIALLY.”

Furthermore, internal analysis information of each document is provided. For example, the weight information of an index term (document frequency, term frequency, etc.) is analyzed and then provided.

That is, the TRS means 110 receives a query based on a technical term and context information from the TLA means 180, searches databases 120a, 120b, 130a to 130c and 140, extracts both a document set including the query and posting information including the index weight information of each document, that is, the document set in a specific technological field, and provides the extracted data to the TAMA 170.

A TAMA 170 and a Semi-Automatic Tech-Tracking engine (SATT) 160 are connected to the IIFP 190. The SATT 160 is means responsible for substantial services, and construct various types of services using triple sets (technical terms, relations, and technical terms) provided through the outputs of the TAMA 170 and an academic database access API processed by the IIFP 190.

The TAMA 170 extracts sentences including a plurality of technical terms using the access API of the IIFP 190.

The final outputs of the TAMA 170 are chiefly divided into two types of result triples, that is, triples extracted by a Concrete Relation Extraction Module (CREM) 172 and triples extracted by an Abstract Relation Extraction Module (AREM) 174, depending on the degree of conceptualization of the relations. With regard to the triples extracted by the CREM 172, relations between technical names are very concrete and are mapped to verb synsets which realize the hypernyms of WordNet. The triples extracted by the CREM 172 may have relations, such as (change, alter, modify), (act, move), (make, create), and (transfer).

With regard to the triples extracted by the AREM 174, relations between technical names are abstract, are mapped at the level of the semantic classification of verbs, and are mapped to the verb concept classification systems of WordNet. The triples extracted by the AREM 174 may have relations such as “change,” “cognition,” “competition,” “contact,” “creation,” “motion,” “possession,” “communication,” “perception” and “state.”

The reason why the result triples of the TAMA 170 are divided into the two types is to support the diversity of external application services using the triples. Depending on the circumstances, a browsing service or a keyword extension service based on very in-depth relations between technical terms may be required. In-depth application services, such as reasoning, extension and transference, based on somewhat abstract relations may be required. For higher-order semantic-based services, a result triple in which the above two types of triples are combined together may be required.

In the present invention, since WordNet has been used in order to conceptualize lexicons using clues that are chiefly verbs, the types of conceptualized relations vary depending on the positions where the lexical clues are mapped in WordNet.

Since the CREM 172 has attempted mapping for a total of 13,767 in-depth verb synsets existing in WordNet, the expression concepts thereof are detailed and concrete. In contrast, since the AREM 174 has attempted mapping for a 15 verb concept class system provided by WordNet, the expression concepts thereof are relatively abstract.

As part of basic research, relations between technical terms are extracted from sentences, each having a relatively simple form, based on the construction of the TAMA 170. Although from the viewpoint of the overall workflow or the independence of the individual modules of the STM system 100, it has low direct correlation with the TAMA 170, statistical information for original data is shown in the following table I for reference.

TABLE 1

| | | SIZE |
|---|---|---|
| ITEM | VOLUME (CASES) | (GB) |
| total number of documents (bibliography) | 30,858,830 (100.0%) | 16.0 |
| number of bibliographical cases including | 12,666,438 (42.9%) | 8.0 |
| abstracts | | |
| number of bibliographical cases not | 18,192,392 (57.1%) | 8.0 |
| including abstracts | | |

The total volume of the academic databases was 30 million cases or more, but relation extraction tasks were performed only on bibliographical documents including abstracts because of the considerations concerning quality extraction and sentence extraction tasks.

Referring to FIG. 5, WordNet synset sets are related to each other on the basis of various relations. In the present invention, in order to connect specific verbs to synsets having concepts as comprehensive as possible when synset mapping for the verbs was attempted, a concept mapping scheme based on automatic transference to hypernyms was employed using the hypernym relations shown in this drawing.

The greatest reason why transference to hypernyms is attempted is to reduce diversity by generalizing concepts expressed by specific verbs as much as possible and to ensure a locality in determining nucleus relations and extracting relations for new sentences based on the reduced diversity. As described above, most technological developments pertinent to relation extraction which have been performed so far have been focused on at least one or two (web-based SSRE) to a maximum of 24 (SRE and ACE collections) relations. Accordingly, even in the present invention, experts are empowered to select several types of relations which are frequently and significantly expressed in data and coincide with the knowledge service of the STM system 100, rather than accommodating excessive types of relations, in the task of determining nucleus relations.

The TLA (Tech Language Analyzer) 180 inputs the extraction results obtained by the TAS 150 and the TAMA 170, provides technical term candidates to the TAS using a thesaurus, ontology and a word intelligent network, and provides relations between technical terms to the TAMA.

A thesaurus is a terminology dictionary that is recorded and managed by a computer for the purpose of performing information searching, and it is operated in such a way that the synonyms, antonyms, similar terms, generic terms, narrower terms, related terms, etc. of respective terms are managed for respective items.

Generally, the term ontology refers to a study or an interest concerning what entities exist in the universe, originates from a compound word of the Greek word ‘ONTO’ having a meaning of ‘existence’ and the Greek word ‘LOGIA’ having a meaning of ‘thesis or lecture’, and refers to a field in pursuit of the study of the essence of entities. In computer science and information science, ontology is a data model for describing a specific field, is a set of finite words that describe the relations between concepts, and is technology for reasoning or inference. Ontology is used for the Semantic Web and a Semantic Web service that are used to describe relations to Internet resources in a specific field.

The TLA 180 is a collection of language processing modules that are optimized for scientific and technological databases. The TLA 180 is an in-depth sentence analysis module for extracting and verifying the relations between technologies, a shallow parser for applying partial parsing technology that takes into account sentences difficult to detect and various sentence expressions, and a part-of-speech tagging system that functions to analyze the ambiguity of machine learning-based parts of speech learned based on learning documents including professional information and has an operational speed optimized for the efficient analysis of a large amount of information.

The SATT (Semi-Automatic Tech Tracking Engine) 160 is a module for providing various services using extracted relations. The SATT 160 receives technical terms, context information, relation information and document sets from the TAMA 170, and tracks and extracts technological knowledge based on the relations of the frequency of occurrence, association and extension including the occurrence time, location and author of each technical term. The SATT 160 is configured to include a TRBS 162 and an MIS 164.

The SATT 160 receives extracted technical terms, document content and relation information from the TAS 150 and the TAMA 170, receives accumulated new technical terms and information about relations between technology and technology and technology and documents from the knowledge database, and manually and automatically tracks technological knowledge. The tracked technical terms are relation-based technological knowledge including occurrence time, producer information and location information, are provided to, recorded in and managed by the knowledge database, are provided to the TRBS 162 and the MIS 164, are used for various services, and are output in the form of documents based on diagrams and table information.

The relations include the frequency of occurrence of technical terms over time, relations between technological terms, technology fusion and separation based on distance information in databases, the frequency of occurrence for each location of occurrence, and inference and verification for new terms.

The TRBS 162 receives information about technical terms, relations and document content, receives accumulated information about technical terms, relations and document content from the knowledge database 190, and tracks and provides the results of classification and clustering in the form of technological sets. The TRBS 162 classifies and clusters a large number of document sets of text provided through the SATT 134 based on extracted names and relations between technologies, thereby converting the document sets into meta data.

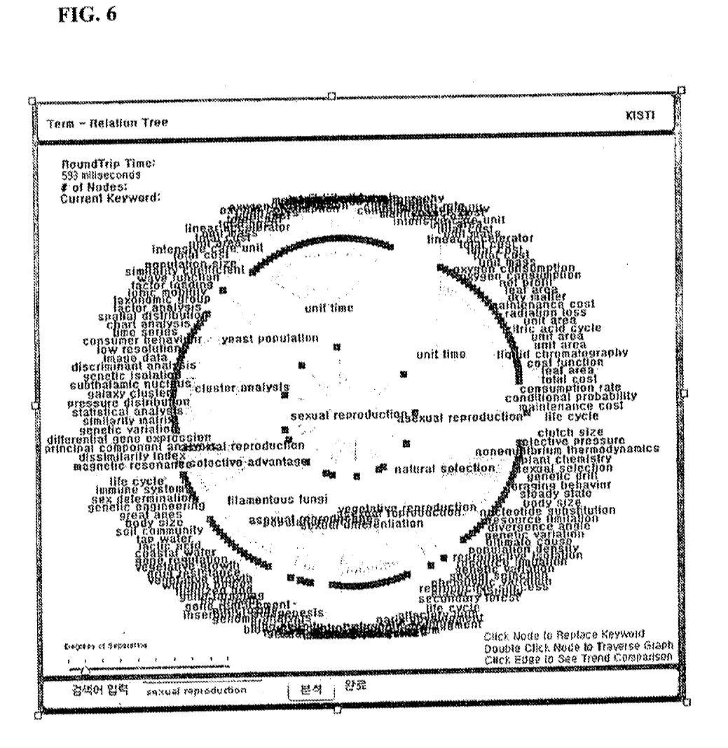

FIG. 6 is a reference diagram showing such relations.

A method of extracting the semantic relation of context according to an example of the present invention will be described below with reference to the accompanying drawings.

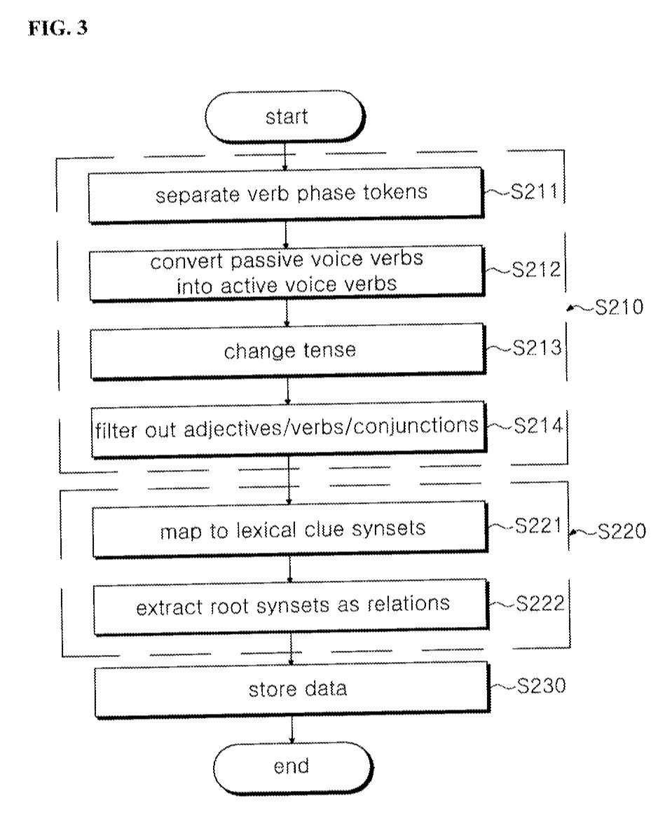

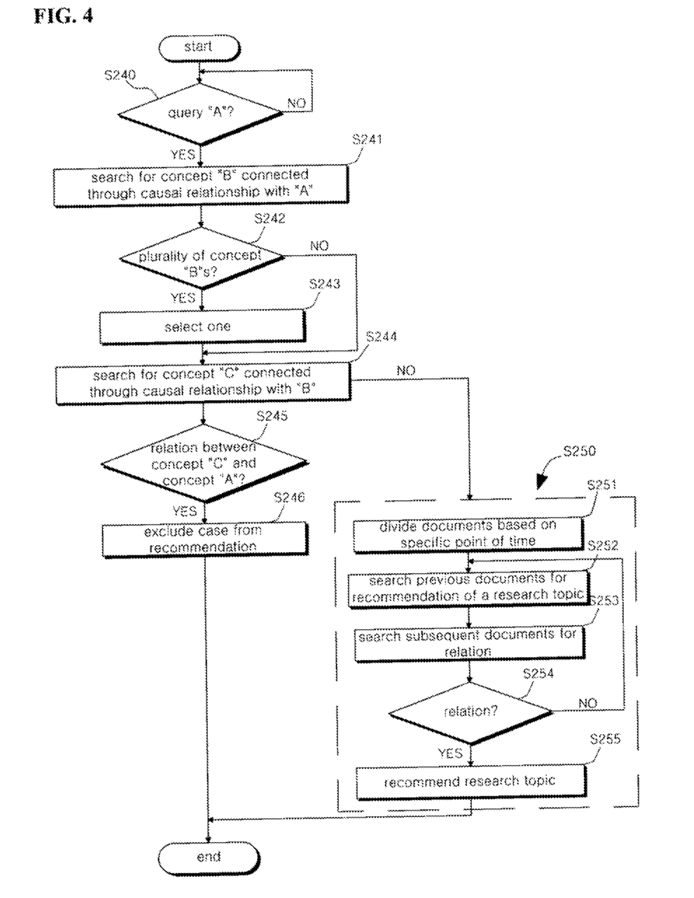

FIG. 3 is a flowchart illustrating a verb phrase conceptualization step according to an example of the present invention. As shown in this drawing, the method of extracting a relation includes the vocabulary word extraction step S210 and the relation extraction step S220 for performing mapping to a desired relation.

The verb phrase conceptualization step includes a total of five detailed processes. The verb phrase unification step S210 refers to a simple unification task for verb phrases that repeatedly appear. The verb phrase token separation step S211 is a token separation task for verb phrases including multi-word phrases, such as “has been moved,” and “was executed.” Step S212 is a passive to active voice conversion step, and is the step of converting verbs expressed in the passive voice into the active voice. Furthermore, the tense conversion step S213 of performing present/past perfect tense conversion and the filtering step S214 of filtering out verb phrases, including adjectives and adverbs, due to chunking error or part-of-speech tagging error (the removal of adjectives, adverbs (˜ly, to)) and the removal of conjunctions are performed. The substantial WordNet mapping step S220 is performed using Java WordNet Interface (JWI) 2.1.4 which was developed by MIT.

At the relation extraction step S220, sentences including the previously extracted technical terms are searched for lexical clues. The lexical clues refer to nucleus words that play crucial roles in the expression of relations. Currently, verbs and verb equivalents, that is, relation lexical clues which are intuitively the clearest ones, have been determined to be the lexical clues, and more words will be continuously determined to be lexical clues. In order to extract lexical clues, a verb phrase token separation task, verb passive to active voice conversion, tense conversion, and a step of filtering adjective/adverb/conjunction are performed. In order to map these to desired relations, WordNet is utilized. Synsets constituting WordNet are connected to each other through various relations. In order to perform mapping to desired relations, the hypernym relation of WordNet is used. Lexical clues are mapped to the Synsets of WordNet at step S221, the highest Root Synset is extracted as a final relation based on the hypernym relation at step S222, and the extracted relation is stored in a database at step S230.

FIG. 5 is a diagram schematically showing a scheme for concept mapping based on transference to hypernyms.

Referring to FIG. 5, synsets constituting WordNet are connected to each other on the basis of various relations. In the present invention, in order to connect specific verbs to synsets having concepts as comprehensive as possible when synset mapping for the verbs is attempted, a scheme for concept mapping based on automatic transference to hypernyms is employed using the hypernym relations shown in this drawing.

The greatest reason why transference to hypernyms is attempted is to reduce diversity by generalizing concepts expressed by specific verbs as much as possible and to ensure a locality in determining nucleus relations and extracting relations for new sentences based on the reduced diversity. As described above, most technological developments pertinent to relation extraction which have been performed so far have been focused on at least one or two (web-based SSRE) to a maximum of 24 (SRE and ACE collections) relations. Accordingly, even in the present invention, experts are empowered to select several types of relations which are frequently and significantly expressed in data and coincide with the knowledge service of the STM system 100, rather than accommodating excessive types of relations, in the task of determining nucleus relations.

The research topic recommendation service can recommend a significant research topic when technical terms and relations have somewhat accumulated. In the current system, all means have not been implemented, and the extraction and purification of relations are being continuously performed. Accordingly, since experimental data for the recommendation service is insufficient, the evaluation of the accuracy, sport, etc. of the research topic recommendation service has not been performed yet. When the implementation of the system has been completed and experimental data has been accumulated, performance measurement tests will be carried out.

In the present invention, the method of implementing a research topic recommendation service for extracting the undiscovered knowledge of public documents on the basis of the hypothesis of Swanson's ABC model has been discussed. Unlike in the existing researches using a statistical technique based on the frequency of concurrence of keywords or depending on descriptors written in controlled language by experts, the present invention proposes the method of parsing the full text of documents and using the semantic relations of context.

In the future, extracted relations and technical terms are purified to be suitable for the scientific and technological document research topic recommendation service, and performance tests will be performed thereon. Currently, documents possessed by us include about eighty million documents composed of three types of documents, that is, patents, papers and research reports, and are sufficient to perform such tasks.

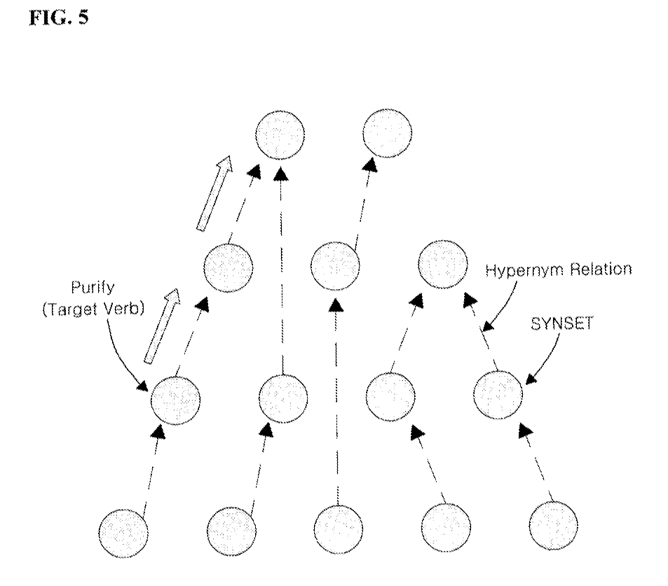

With reference to FIGS. 2 and 4, a method of extracting a relation and recommending a research topic according to an example of the present invention will be described below.

In the method of recommending a research topic, a research topic recommendation service queries extracted vocabulary word “A” after terms and relations have somewhat accumulated at step S240.

Databases are searched for concept “B” connected to vocabulary word “A” in a causal relationship at step S241. That is, databases are searched for a document set classified into a specific technological field and the query and posting information along with the document set and the query and posting information are extracted and are provided to the TAMA means 170.

If a plurality of concept “B”s is retrieved at step S242, one is selected from among them at step S243.

Furthermore, concept “C” connected to concept “B” through a casual relationship is searched for at step S244, and whether there is a relation between the retrieved concept “C” and the concept “A” is determined at step S245.

If it is determined that there is a relation between the concept “C” and the vocabulary word “A” at step S246, it is excluded from a research topic recommendation service. If it is determined that there is no relation between the concept “C” and the vocabulary word “A” at step S246, the process proceeds to a research topic recommendation step S250.

The research topic recommendation step S250 includes step S251 of dividing documents in the databases on the basis of a specific point of time and step S252 of searching documents issued before the specific point of time and recommending a research topic.

Thereafter, documents issued after the specific point of time are searched for a relation at step S253. If it is determined that there is no relation at step S254, it is recommended as a research topic at step S255. If it is determined that there is no relation, step S252 is repeated.

It is possible to implement the method of the present invention on a computer-readable recording medium in the form of computer-readable code. The computer-readable recording medium is a data recording medium that can be read by a computer system. For example, the recording medium includes ROM, RAM, Cache, a hard disk, an optical disk, a floppy disk, and a magnetic tape. Furthermore, there is the case where the method of present invention is implemented in the form of carrier waves. For example, the method of the present invention may be implemented via transmission via the Internet Furthermore, the computer-readable recording medium may be distributed across computer systems connected via a network, and the method of the present invention is stored and executed in the form of code that can be read by a computer in a distributed manner.

Although the present invention has been described only in conjunction with the described specific embodiments in detail, it will be apparent to those skilled in the art that various modifications and variations are possible within the scope of the technical spirit of the present invention and it is natural that such modifications and variations pertain to the attached claims.

### INDUSTRIAL APPLICABILITY

The present invention is intended to automatically search for patterns in a large amount of data, relate a large number of documents to each other and then mine vocabulary words. Since the present invention finds new knowledge for an approach to the problem of searching for undiscovered public knowledge using a method of extracting the semantic relation of context by parsing documents, the present invention has the industrial utilization advantages of improving overall searching efficiency and utility regarding massive databases.

1. A method of extracting a semantic relation of context, comprising the steps of:
(a) querying a specific vocabulary word;
(b) searching databases for a first concept connected to the queried vocabulary word in a causal relationship;
(c) searching the databases for a second concept connected to the first concept in a causal relationship;
(d) determining whether there is a relation between the retrieved vocabulary word and the second concept; and
(e) if there is no relation between the vocabulary word and the second concept, recommending this case as a research topic.

2. The method according to claim 1, wherein the step (b) comprises the step of, if the first concept comprises a plurality of first concepts, selecting one from among the plurality of first concepts.

3. The method according to claim 2, wherein the step (d) comprises the step of, if it is determined that there is a relation between the vocabulary word and the second concept, excluding this case from a research topic recommendation service.

4. The method according to claim 1, wherein the step (e) comprises the steps of:
dividing documents of the databases on a basis of a specific point of time;
searching documents issued before the specific point of time, and recommending a research topic;
searching documents issued after the specific point of time for a relation; and
if it is determined that there is a relation at the previous step, recommending this case as a research topic.

5. The method according to claim 1, wherein the step (d) comprises:
the step of extracting vocabulary words; and
the relation extraction step for mapping the vocabulary words to desired relations.

6. The method according to claim 5, wherein the relation extraction step comprises mapping the vocabulary words to Synsets and extracting Root Synsets as relations.

7. A recording medium recording a program source of the method of extracting semantic relations of context set forth in claim 1.

8. An apparatus for extracting semantic relations of context, comprising:
a TRS for managing overall data for which technical terms have been detected and providing search service that can be used by other modules;
a TAS for searching the data of the TRS for technical terms using dictionaries and extracting new terms;
a TLA for performing chucking and tagging on source documents to facilitate detection of technical terms and relation extraction;
a TAMA for extracting semantic relations of context by parsing documents among the technical terms using the TLA, and performing conceptualization using WordNet; and
a SATT for providing various services using the extracted semantic relations.

9. The apparatus according to claim 8, further comprising an IIFP for providing support so as to enable systematic access to precisely processed massive databases;
wherein the IIFP provides various types of services using an academic database access API processed by the TAMA and the SATT.

10. The apparatus according to claim 9, wherein the TAMA comprises:
a CREM configured such that relations between technical names are very concrete and configured to perform mapping to hypernym verb synsets of the WordNet; and
an AREM configured such that relations between technical names are abstract and relations are mapped at a verb semantic classification level and configured to perform mapping to a verb concept classification system of the WordNet.

11. The apparatus according to claim 9, wherein the TAMA extracts vocabulary words and extracts relation for mapping the extracted vocabulary words to desired relations.

12. The apparatus according to claim 11, wherein the TAMA is configured to extract relations from document sets input from the TRS using part-of-speech information patterns of technical terms and vocabulary, automatically recheck existing relation information, automatically and manually verify the relations, analyze the relations using thesauruses, ontology and a word intelligent network, provide analysis results to the AREM, and provide relation information based on specific technology to a knowledge database.

13. The apparatus according to claim 9, wherein the relations are configured to map the vocabulary words to the Synsets and extract Root Synsets as relations.

14. The recording medium according to claim 7, wherein the step (b) comprises the step of, if the first concept comprises a plurality of first concepts, selecting one from among the plurality of first concepts.

15. The recording medium according to claim 14, wherein the step (d) comprises the step of, if it is determined that there is a relation between the vocabulary word and the second concept, excluding this case from a research topic recommendation service.

16. The recording medium according to claim 7, wherein the step (e) comprises the steps of:
dividing documents of the databases on a basis of a specific point of time;
searching documents issued before the specific point of time, and recommending a research topic;
searching documents issued after the specific point of time for a relation; and
if it is determined that there is a relation at the previous step, recommending this case as a research topic.

17. The recording medium according to claim 7, wherein the step (d) comprises:
the step of extracting vocabulary words; and
the relation extraction step for mapping the vocabulary words to desired relations.

18. The recording medium according to claim 17, wherein the relation extraction step comprises mapping the vocabulary words to Synsets and extracting Root Synsets as relations.

19. The apparatus according to claim 10, wherein the relations are configured to map the vocabulary words to the Synsets and extract Root Synsets as relations.

20. The apparatus according to claim 11, wherein the relations are configured to map the vocabulary words to the Synsets and extract Root Synsets as relations.

21. The apparatus according to claim 12, wherein the relations are configured to map the vocabulary words to the Synsets and extract Root Synsets as relations.
